(19) United States
(12) Patent Application Publication
(10) Pub. No.: US 2019/0012284 A1
(43) Pub. Date: Jan. 10, 2019

(54) ELECTRONIC SYSTEM AND CHARGING CONTROLLER CIRCUIT THEREOF

(71) Applicant: EcoFlow Technology Limited, Shenzhen (CN)

(72) Inventors: Mingze MA, Shenzhen (CN); Fan ZHENG, Shenzhen (CN)

(21) Appl. No.: 15/806,974

(22) Filed: Nov. 8, 2017

(30) Foreign Application Priority Data
Jul. 5, 2017 (CN) 201710544134.3

(51) Int. Cl. G06F 13/38; G06F 13/42; G06F 13/40

(52) U.S. Cl. CPC G06F 13/385; G06F 2213/0042; G06F 13/4068; G06F 13/4286

(57) ABSTRACT

This disclosure relates to electronic technologies, and in particular relates to A charging controller circuit comprising: a first USB interface controller circuit used in a charger device and configured to control a USB interface of the charger device; and a second USB interface controller circuit used in a device to be charged and configured to control a USB interface of the device to be charged; the first USB interface controller circuit comprises a first processing module; the second USB interface controller circuit comprises a second processing module; the second processing module is configured to transmit a second function signal between the charger device and the device to be charged.

### CROSS REFERENCE TO RELATED APPLICATION

This application claims priority to Chinese Patent Application No. 201710544134.3, entitled “ELECTRONIC SYSTEM AND CHARGING CONTROLLER CIRCUIT THEREOF ” filed on Jul. 5, 2017, the content of which is expressly incorporated by reference herein in its entirety.

### FIELD OF THE INVENTION

This disclosure relates to electronic technologies, and in particular relates to an electronic system and the charging controller circuit thereof.

### BACKGROUND OF THE INVENTION

To effect the transmission of various function signals such as a discharging function signal, a communication function signal, a video function signal and other private communication signals and so on, a regular electronic device typically needs to be configured with several interfaces. However, when a USB interface is implementing a certain function signal, not all pins are used in the interface. Such as in an ordinary charger, only the VBUS/GND pins of the interface are used for the discharging function., no other pins of the interface are needed. Therefore, there are redundancy and idling.

### SUMMARY OF THE INVENTION

Accordingly, it is necessary to provide a charging controller circuit and an electronic system with improved interface use ratio.

A charging controller circuit includes: a first universal serial bus (USB) interface controller circuit used in a charger device and configured to control a USB interface of the charger device; and a second USB interface controller circuit used in a device to be charged and configured to control a USB interface of the device to be charged; the first USB interface includes a first pin and a second pin; the second USB interface includes a third pin and a forth pin; the first pin is connected to the third pin to transmit a first function signal; the second pin is connected to the forth pin whereby the device to be charged is charged by the charger device; the first USB interface controller circuit includes a first processing module electrically connected to the first pin and the second pin, respectively; the second USB interface controller circuit includes a second processing module connected to the third pin thereby electrically connecting the first pin; the second processing module is configured to transmit a second function signal between the charger device and the device to be charged; and he second function signal is different from the first function signal, and neither of the first function signal and the second function signal is a charging function signal; the first processing module acquires the second function signal through the first pin and controls the charger device to charge the device to be charged through the second pin.

An electronic system includes a charger device and a device to be charged; the charger device is electrically connected to and charge the device to be charged; and a charging controller circuit includes: a first USB interface controller circuit used in a charger device and configured to control a USB interface of the charger device; and a second USB interface controller circuit used in a device to be charged and configured to control a USB interface of the device to be charged; the USB interface of the charger device includes a first pin and a second pin; the USB interface of the device to be charged includes a third pin and a forth pin; the first pin is connected to the third pinto transmit a first function signal; the second pin is connected to the forth pin whereby the device to be charged is charged by the charger device; the first USB interface controller circuit includes a first processing module electrically connected to the first pin and the second pin respectively; the second USB interface controller circuit includes a second processing module connected to the third pin thereby electrically connecting the first pin; the second processing module is configured to effect a second function signal transmission between the charger device and the device to be charged; the second function signal is different from the first function signal, and neither is a charging function signal; the second function signal is acquired by the first processing module through the first pin and whereby the charger device is controlled to charge the device to be charged through the second pin; the charger device includes the first USB controller circuit, and the device to be charged includes the second USB controller circuit.

The above and other features of the invention including various novel details of construction and combinations of parts, and other advantages, will now be more particularly described with reference to the accompanying drawings and pointed out in the claims.

### BRIEF DESCRIPTION OF THE DRAWINGS

The technical solutions of the present invention will be clearly and completely described in the following with reference to the accompanying drawings. It is obvious that the embodiments to be described are only a part rather than all of the embodiments of the present invention. All other embodiments obtained by persons skilled in the art based on the embodiments of the present invention without creative efforts shall fall within the protection scope of the present invention.

FIG. 1 is a block diagram of the internal structure of the charger device and the device to be charged according to an embodiment;

FIG. 2 is a block diagram of the circuit structure of the charger device and the device to be charged according to an embodiment;

FIG. 3 is a block diagram of the circuit structure of the charger device according to an embodiment; and

FIG. 4 is a block diagram of the circuit structure of the charger device and the device to be charged according to another embodiment.

### DETAILED DESCRIPTION OF THE EMBODIMENTS

The present disclosure will be described in details in combination with the accompanying drawings and embodiments such that the purpose, technical solution and advantages of the present disclosure will be more apparent. It should be understood that the particular embodiments are described for the purpose of illustrating as opposed to restricting the present invention.

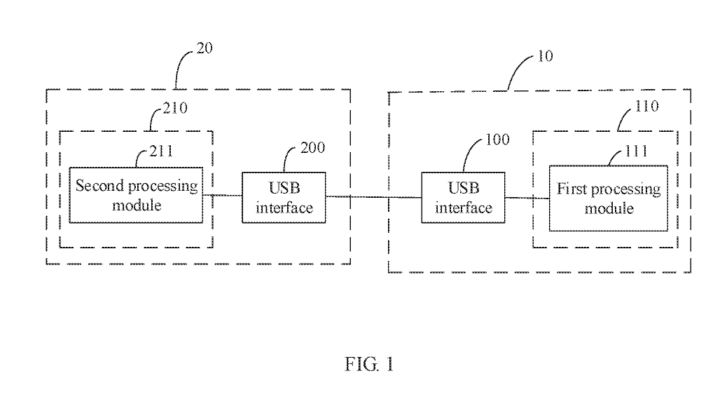

As illustrated in FIG. 1, a charging controller circuit according to an embodiment includes a first USB interface controller circuit 110 and a second USB interface controller circuit 210. The first USB interface controller circuit 110 is used in the charger device 10 and configured to control the USB interface 100 thereof. The second USB interface controller circuit 210 is used in the device to be charged 20 to control the USB interface 200 thereof.

The USB interface 100 of the charger device 10 includes a first pin and a second pin. The USB interface 200 of the charger device 20 includes a third pin and a forth pin. The first pin is connected to the third pin to transmit a first function signal. The first function signal is not a charging function signal. i.e., neither the first pin nor the third pin is used for charging connection. The second pin is connected to the forth pin. The charger device 10 is connected to the forth pin in the USB interface 200 via the second pin in the USB interface 100 to charge the device to be charged 20.

In the present embodiment, the first USB interface controller circuit 110 includes a first processing module 111. The first processing module 111 is respectively electrically connected to the first pin and the second pin of the USB interface 100. The second USB interface controller circuit 210 includes a second processing module 211. The second processing module 211 is connected to the third pin thereby electrically connecting the first pin of the USB interface 100. The second processing module 211 is configured to implement the transmission of the second function signal between the charger device 10 and the device to be charged 20.

The second function signal is not a charging function signal. The second function signal is different from the first function signal. The first processing module 111 acquires the second function signal through the first pin of the USB interface 100 and, through the second pin of the USB interface 100, control the charger device 10 to charge the device to be charged 20 according to the second function signal.

According to the foregoing charging controller circuit, the first USB interface controller circuit 110 is used in the charger device 10 to control the USB interface 100 thereof, the second USB interface controller circuit 210 is used in the device to be charged 20 to control the USB interface 200 thereof. The second processing module 211 in the second USB interface controller circuit 210 provides the USB interface 100 with the second function signal through the third pin in the USB interface 200, the first processing module 111 in the first USB interface controller circuit 110 obtains the second function signal (which is not a charging function signal) via the first pin of the USB interface 100 and, through the second pin of the USB interface 100, controls the charger device 10 to charge the device to be charged 20 according to the second function signal. The foregoing charging controller circuit can control pins in the USB interface 100 and USB interface 200 that do not involve the charging functionality to transmit other function signals, and perform charging control according to the signals. As such, the use ratio of the interfaces are improved, the redundancy and idling of the interfaces are avoided.

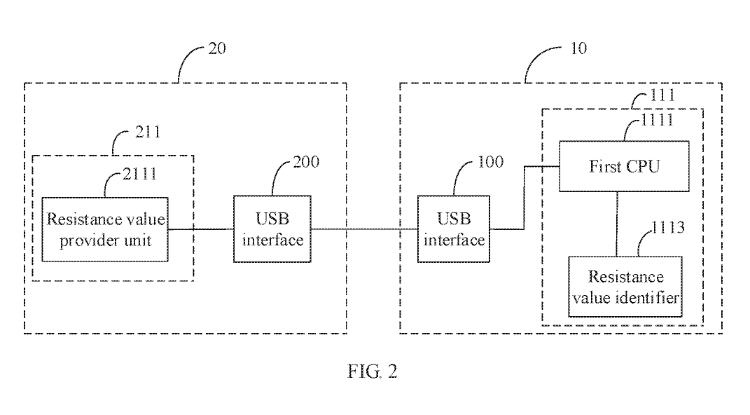

As illustrated in FIG. 2, the first processing module 111 according to an embodiment includes a first CPU 1111 and a resistance value identifying unit 1113. The first CPU 1111 is electrically connected the resistance value identifying unit 1113. The first CPU 1111 is electrically connected to the first pin and the second pin of the USB interface 100. The second processing module 211 includes a resistance value providing unit 2111. The resistance value providing unit 2111 is electrically connected to the third pin of the USB interface 200. The first pin of the USB interface 100 is electrically connected to the third pin of the USB interface 200. The second function signal is a resistance value signal. The resistance value providing unit 2111 provides the first pin of the USB interface 100 with the resistance value signal through the third pin of the USB interface 200. The first CPU 1111 is electrically connected to the first pin of the USB interface 100 to acquire the resistance value signal through the first pin and send the resistance value signal to the resistance value identifying unit 1113 for resistance value determination. The resistance value identification result is sent by the resistance value identifying unit 1113 to the first CPU 1111. The first CPU 1111, through the second pin of the USB interface 100, control the charger device 10 to charge the device to be charged 20 according to the resistance value identification result.

In the present embodiment, the USB interface 100 and the USB interface 200 are both TYPE-C interfaces. The second pin of the USB interface 100 includes a VBUS pin and a GND pin. The forth pin of the USB interface 200 also includes a VBUS pin and a GND pin. The VBUS pin of the USB interface 100 is connected to the VBUS pin of the USB interface 200. The GND pin of the USB interface 100 is connected to the GND pin of the USB interface 200. Via the VBUS pin and the GND pin in the USB interface 100 and the VBUS pin and GND of the USB interface 200, the charging by the charger device 10 to the device to be charged 20 can be implemented.

The first pin in the USB interface 100 is a CC pin. The third pin in the USB interface 200 is also a CC pin. In other embodiments, the first pin in the USB interface 100 can also be a D pin or other pins that are not used for charging function, Correspondingly, the third pin in the USB interface 200 can also be a D pin or other pins that are not used for charging function. In the present embodiment, the resistance value providing unit 2111 is electrically connected to the CC pin in the USB interface 100 through the CC pin in the USB interface 200, so as to provide the CC pin of the USB interface 100 with a first resistance value signal. In the present embodiment, the resistance value providing unit 2111 is electrically connected to the CC pin in the USB interface 100 through the CC pin in the USB interface 1111, so as to provide the CC pin of the USB interface 100 with a first resistance value signal. The first CPU 1111 send the first resistance value signal to the resistance value identifying unit 1113 for resistance value determination. The resistance value identification result is sent by the resistance value identifying unit 1113 to the first CPU 1111. The first CPU 1111, through VBUS pin and the GND pin of the USB interface 100, controls the charger device 10 to charge the device to be charged 20 according to the resistance value identification result.

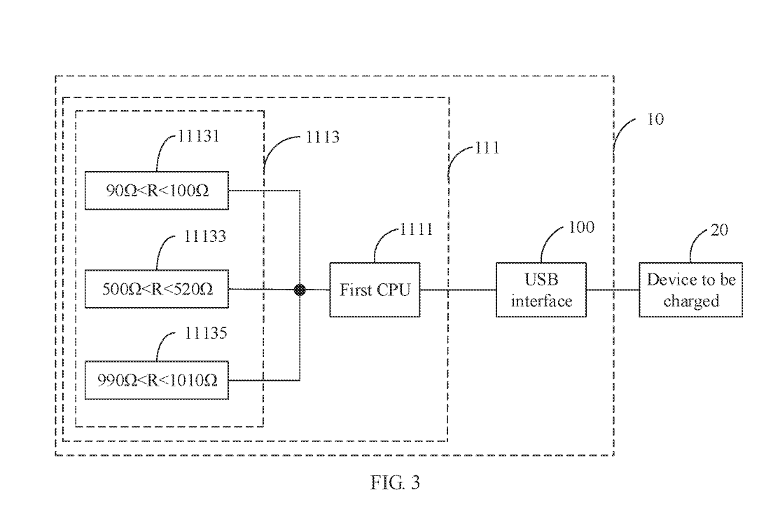

In the embodiment shown in FIG. 3, the resistance value identifying unit 1113 according to an embodiment includes a first resistance value matching unit 11131, a second resistance value matching unit 11133 and a third resistance value matching unit 11135. The first resistance value matching unit 11131, the second resistance value matching unit 11133 and the third resistance value matching unit 11135 are all respectively electrically connected to the first CPU 1111. The resistance value range R of the first resistance value matching unit 11131 is 90Ω<R<100Ω. When the first resistance value signal acquired by the first CPU 1111 is within the resistance value range of the first resistance value matching unit 11131, the first CPU 1111, through the VBUS pin and the GND pin in the USB interface 100, controls charger device 10 to charge the device to be charged 20 with a voltage at 5V and a current at 1 A. The resistance value range R of the first resistance value matching unit 11133 is 90Ω<R<520Ω. When the first resistance value signal acquired by the first CPU 1111 is within the resistance value range of the second resistance value matching unit 11133, the first CPU 1111, through the VBUS pin and the GND pin in the USB interface 100, controls charger device 10 to charge the device to be charged 20 with a voltage at 1.5V and a current at 2 A. The resistance value range R of the third resistance value matching unit 11135 is 90Ω<R<1010Ω. When the first resistance value signal acquired by the first CPU 1111 is within the resistance value range of the third resistance value matching unit 11135, the first CPU 1111, through the VBUS pin and the GND pin in the USB interface 100, controls charger device 10 to charge the device to be charged 20 with a voltage at 1.8V and a current at 3 A.

In the present embodiment, when the resistance value of the first resistance value signal does not fall into the resistance value range of the first resistance value matching unit 11131, the second resistance value matching unit 11133 and the third resistance value matching unit 11135, the first CPU 1111, through the VBUS pin and the GND pin in the USB interface 100, controls the charger device 10 to charge the device to be charged 20 with a conventional charging voltage and current.

In other embodiments, the first processing module 111 can also include a forth CPU and a current value identifying unit. The forth CPU is electrically connected to the current value identifying unit. The second processing module 211 includes a current value providing unit. The current value providing unit is electrically connected to the third pin of the USB interface 200. The first pin of the USB interface 100 is electrically connected to the third pin of the USB interface 200. The current value providing unit provides the first pin of the USB interface 100 with the current value signal through the third pin of the USB interface 200. The first CPU 1111 is electrically connected to the first pin of the USB interface 100 to thereby acquire the current value signal and send the current value signal to the current value identifying unit for current value determination. The current value identification result is sent by the current value identifying unit to the forth CPU. The forth CPU, through the second pin of the USB interface 100, controls the charger device 10 to charge the device to be charged 20 according to the current value identification result.

In other embodiments, the first processing module 111 can also include a fifth CPU and a voltage value identifying unit. The fifth CPU is electrically connected to the voltage value identifying unit. The second processing module 211 includes a voltage value providing unit. The voltage value providing unit is electrically connected to the third pin of the USB interface 200. The first pin of the USB interface 100 is electrically connected to the third pin of the USB interface 200. The voltage value providing unit provides the first pin of the USB interface 100 with the voltage value signal through the third pin of the USB interface 200. The first CPU 1111 is electrically connected to the first pin of the USB interface 100 to thereby acquire the voltage value signal and send the voltage value signal to the voltage value identifying unit for voltage value determination. The voltage value identification result is sent by the voltage value identifying unit to the fifth CPU. The fifth CPU, through the second pin of the USB interface 100, controls the charger device 10 to charge the device to be charged 20 according to the voltage value identification result.

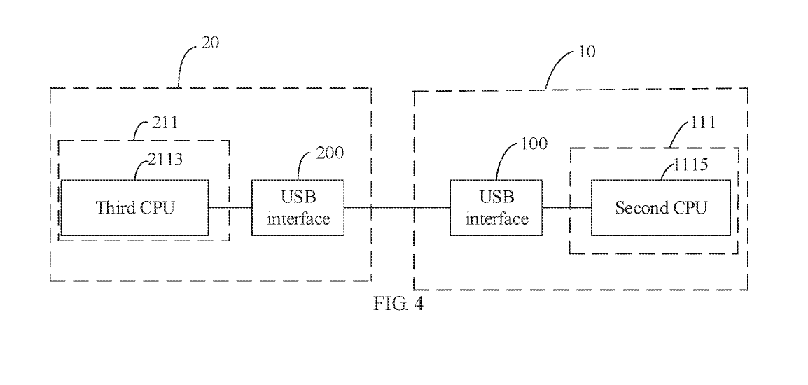

As illustrated in FIG. 4, the first processing module 111 according to an embodiment includes a second CPU 1115. The first CPU 1115 is respectively electrically connected to the first pin and the second pin of the USB interface 100. The second processing module 211 includes a third CPU 2113. The third CPU 2113 is respectively electrically connected to the third pin and the forth pin of the USB interface 200. The charger device 10 is connected to the forth pin in the USB interface 200 via the second pin in the USB interface 100 to charge the device to be charged 20. The first pin of the USB interface 100 is connected to the third pin of the USB interface 200. The second function signal is a handshaking signal. The second CPU 1115 is connected to the third CPU 2113 via the first pin in the USB interface 100 and the third pin in the USB interface 200 to transmit the private protocol to thereby effect the transmitting of the handshaking signal between the second CPU 1115 and the third CPU 2113. The second CPU 1115, through the second pin of the USB interface 100, controls the charger device 10 to charge the device to be charged 20 according to the handshaking signal.

The USB interface 100 and the USB interface 200 are both TYPE-C interfaces. The second pin of the USB interface 100 includes a VBUS pin and a GND pin. The forth pin of the USB interface 200 also includes a VBUS pin and a GND pin. The VBUS pin of the USB interface 100 is connected to the VBUS pin of the USB interface 200. The GND pin of the USB interface 100 is connected to the GND pin of the USB interface 200. Via the VBUS pin and the GND pin in the USB interface 100 and the VBUS pin and GND of the USB interface 200, the charging by the charger device 10 to the device to be charged 20 can be implemented. The first pin in the USB interface 100 is a RX pin. The third pin in the USB interface 200 is a RX pin. The RX pin in the USB interface 100 is electrically connected to the second CPU 1115. The RX pin in the USB interface 200 is electrically connected to the third CPU 2113. The RX pin of the USB interface 100 is connected to the RX pin of the USB interface 200. The second CPU 1115 is connected to the RX pin of the USB interface 200 via the RX pin in the USB interface 100 to thereby effect the transmitting of the private protocol with the third CPU 2113. The second CPU 113, through the VBUS pin and the GND pin of the USB interface 100, controls the charger device 10 to charge the device to be charged 20 according to the handshaking signal of the private protocol.

When the second CPU 1115 detects that the private protocol is transmitted between the charger device 10 and the device to be charged 20 through the RX pins thereof and the handshaking is a success, the second CPU 1115, through the VBUS pin and the GND pin of the USB interface 100, controls the charger device 10 to charge the device to be charged 20 swiftly. When the second CPU 1115 detects that the private protocol is transmitted between the charger device 10 and the device to be charged 20 through the RX pins thereof but the handshaking is not a success, the second CPU 1115, through the VBUS pin and the GND pin of the USB interface 100, controls the charger device 10 to charge the device to be charged 20 slowly/conventionally.

In other embodiments, the first pin in the USB interface 100 can also be a TX pin. The corresponding third pin in the USB interface 200 is a TX pin. The second CPU 113 is connected to the TX pin of the USB interface 200 via the TX pin in the USB interface 100 to thereby effect the transmitting of the private protocol. Besides, in other embodiments, the first pin in the USB interface 100 can also be other pins that are not used for charging connection. Correspondingly, the third pin in the USB interface 200 can also be other pins that are not used for charging connection.

In the case of a conventional TYPE-C interface transmission PD protocol, the charger device 10 and the device to be charged 20 both need a protocol controlling chip and a CPU to effect the PD protocol transmission. In the event of the private protocol transmission between the TX pin or RX pin herein, the charger device 10 and the device to be charged 20 both require only one CPU to effect the private protocol transmission. As such, the charging controller circuit can reduce the cost of the product.

An electronic system is also provided. The electronic system includes a charger device and a device to be charged. The charger device is electrically connected to the device to be charged to charge the latter. The electronic system also includes a charging controller circuit according to the foregoing embodiments. The charger device includes the first USB interface controller circuit in the charging controller circuit. The device to be charged includes the second USB interface controller circuit in the charging controller circuit.

The different technical features of the above embodiments can have various combinations which are not described for the purpose of brevity. Nevertheless, to the extent the combining of the different technical features do not conflict with each other, all such combinations must be regarded as being within the scope of the disclosure.

The foregoing implementations are merely specific embodiments of the present disclosure, and are not intended to limit the protection scope of the present disclosure. It should be noted that any variation or replacement readily figured out by persons skilled in the art within the technical scope disclosed in the present disclosure shall all fall into the protection scope of the present disclosure. Therefore, the protection scope of the present disclosure shall be subject to the protection scope of the claims.

What is claimed is:

1. A charging controller circuit comprising:
a first universal serial bus (USB) interface controller circuit used in a charger device and configured to control a USB interface of the charger device; and
a second USB interface controller circuit used in a device to be charged and configured to control a USB interface of the device to be charged;
wherein the first USB interface comprises a first pin and a second pin; the second USB interface comprises a third pin and a forth pin; the first pin is connected to the third pin to transmit a first function signal; the second pin is connected to the forth pin whereby the device to be charged is charged by the charger device;
wherein the first USB interface controller circuit comprises a first processing module electrically connected to the first pin and the second pin, respectively; the second USB interface controller circuit comprises a second processing module connected to the third pin thereby electrically connecting the first pin; the second processing module is configured to transmit a second function signal between the charger device and the device to be charged; and
wherein the second :function signal is different from the first function signal, and neither of the first :function signal and the second function signal is a charging function signal; the first processing module acquires the second function signal through the first pin and controls the charger device to charge the device to be charged through the second pin.

2. The circuit of claim 1, wherein the first processing module comprises a first CPU and a resistance value identifying unit, the first CPU is electrically connected to the resistance value identifying unit, the first CPU is connected to the first pin and the second pin, respectively; the second processing module comprises a resistance value providing unit; the second function signal is a resistance value signal, the resistance value providing unit is electrically connected to the third pin to thereby provide the resistance value signal to the first pin; the first CPU is configured to acquire the resistance value signal through the first pin and send the resistance value signal to the resistance value identifying unit for resistance value identification, the resistance value identifying unit sends the result of the resistance value identification to the first CPU; the first CPU, through the second pin, controls the charger device to charge the device to be charged according to the result.

3. The circuit of claim 2, wherein the USB interfaces of the charger device and the device to be charged are both TYPE-C interfaces; the second pin comprises a VBUS pin and a GND pin; the forth pin comprises a VBUS pin and a GND pin; the VBUS pin of the second pin is electrically connected to the VBUS pin of the forth pin; the GND pin of the second pin is electrically connected to the GNU pin of the forth pin; the VBUS pin and the GND pin of the second pin of the charger device are respectively electrically connected to the VBUS pin and the GND pin of the device to be charged to charge the device to be charged; the first pin is a first CC pin; the forth pin is a second CC pin; the first CC pin is electrically connected to the second CC pin; the resistance value providing unit is electrically connected to the second CC pin to provide the resistance value signal thereto; the first CPU is electrically connected to the first CC pin to thereby acquire and send the resistance value signal to the resistance value identifying unit for resistance value identification; the first CPU, through the VBUS pin and the GND pin of the second pin, controls the charger device to charge the device to be charged according to the resistance value identification result.

4. The circuit of claim 3, wherein the resistance value identifying unit comprises a first resistance value matching unit electrically connected to the first CPU; a resistance value range R of the first resistance value matching unit is 90Ω<R<100Ω;
when the resistance value of the resistance value signal is within the resistance value range of the first resistance value matching unit, the first CPU, through the VBUS pin and the GND pin, controls the charger device to charge the device to be charged with a voltage at 5 V and a current at 1 A.

5. The circuit of claim 3, wherein the resistance value identifying unit further comprises a second resistance value matching unit electrically connected to the first CPU; a resistance value range R of the second resistance value matching unit is 500Ω<R<520Ω; when the resistance value of the resistance value signal is within the resistance value range of the second resistance value matching unit, the first CPU, through the VBUS pin and the GND pin, controls the charger device to charge the device to be charged with a voltage at 15V and a current at 2 A.

6. The circuit of claim 3, wherein the resistance value identifying unit further comprises a third resistance value matching unit electrically connected to the first CPU; a resistance value range of the third resistance value R matching unit is 990Ω<R<1010Ω; when the resistance value of the resistance value signal is within the resistance value range of the third resistance value matching unit, the first CPU, through the VBUS pin and the GND pin, controls the charger device to charge the device to be charged with a voltage at 18V and a current at 3 A.

7. The circuit of claim 1, wherein the first processing module comprises a second CPU respectively electrically connected to the first pin and the second pin; the second processing module comprises a third CPU electrically connected to the third pin; the second function signal is a handshaking signal which is transmitted by the second CPU through the first pin and the third pin and transmits protocol with the third CPU; the second CPU, through the second pin, controls the charger device to charge the device to he charged according to the handshaking signal.

8. The circuit of claim 7, wherein the USB interfaces of the charger device and the device to be charged are both TYPE-C interfaces; the second pin comprises a VBUS pin and a GND pin; the forth pin comprises a VBUS pin and a GND pin; the VBUS pin of the second pin is electrically connected to the VBUS pin of the forth pin; the GND pin of the second pin is electrically connected to the GND pin of the forth pin; the VBUS pin and the GND pin of the second pin of the charger device are respectively electrically connected to the VBUS pin and the GND pin of the device to be charged to charge the device to be charged; the first pin is a first RX pin; the third pin is a second RX pin; the second. CPU is electrically connected to the first RX pin; the third CPU is electrically connected to the second RX pin; the second CPU is electrically connected to the third CPU through the first RX pin and the second RX pin and transmits a private protocol; the second CPU, through the VBUS pin and the GND pin of the second pin, controls the charger device to charge the device to be charged according to the handshaking signal.

9. The circuit of claim 7, wherein the USB interfaces of the charger device and the device to be charged are both TYPE-C interfaces; the second pin comprises a VBUS pin and a GNU pin; the forth pin comprises a VBUS pin and a GND pin; the VBUS pin of the second pin is electrically connected to the VBUS pin of the forth pin; the GND pin of the second pin is electrically connected to the GND pin of the forth pin; the VBUS pin and the GND pin of the second pin of the charger device are respectively electrically connected to the VBUS pin and the GND pin of the device to be charged to charge the device to he charged; the first pin is a first TX pin; the third pin is a second TX pin; the second CPU is electrically connected to the first TX pin; the third CPU is electrically connected to the second TX pin; the second CPU is electrically connected to the third CPU through the first TX pin and the second TX pin and transmits a private protocol; the second CPU, through the VBUS pin and the GND pin of the second pin, controls the charger device to charge the device to be charged according to the handshaking signal.

10. The circuit of claim 1, wherein the first processing module further comprises a forth CPU and a current value identifying unit; the forth CPU is electrically connected to the current value identifying unit; the second processing module comprises a current value providing unit electrically connected to the third pin of the USB interface; the first pin of the USB interface is electrically connected to the third pin of the USB interface; the current value providing unit provides the first pin of the USB interface with the current value signal through the third pin of the USB interface; the first CPU is electrically connected to the first pin of the USB interface to thereby acquire the current value signal and send the current value signal to the current value identifying unit for current value determination; a current value identification result is sent by the current value identifying unit to the forth CPU; the forth CPU, through the second pin of the USB interface, controls the charger device to charge the device to be charged according to the current value identification result.

11. The circuit of claim 1, wherein the first processing module further comprises a fifth CPU and a voltage value identifying unit; the fifth CPU is electrically connected to the voltage value identifying unit; the second processing module comprises a voltage value providing unit; the voltage value providing unit is electrically connected to the third pin of the USB interface; the first pin of the USB interface is electrically connected to the third pin of the USB interface; the voltage value providing unit: provides the first pin of the USB interface with the voltage value signal through the third pin of the USB interface; the first CPU is electrically connected to the first pin of the USB interface to thereby acquire the voltage value signal and send the voltage value signal to the voltage value identifying unit for voltage value determination; the voltage value identification result is sent by the voltage value identifying unit to the fifth CPU; the fifth CPU, through the second pin of the USB interface, controls the charger device to charge the device to be charged according to the voltage value identification result.

12. An electronic system comprising:
a charger device;
a device to be charged; wherein the device is electrically connected to the charger device; and
a charging controller circuit comprising:
a first USB interface controller circuit used in a charger device and configured to control a USB interface of the charger device; and
a second USB interface controller circuit used in a device to be charged and configured to control a USB interface of the device to be charged;
wherein the USB interface of the charger device comprises a first pin and a second pin; the USB interface of the device to be charged comprises a third pin and a forth pin; the first pin is connected to the third pin to transmit a first function signal;
the second pin is connected to the forth pin whereby the device to be charged is charged by the charger device;
wherein the first USB interface controller circuit comprises a first processing module electrically connected to the first pin and the second pin respectively;
wherein the second USB interface controller circuit comprises a second processing module connected to the third pin thereby electrically connecting the first pin; the second processing module is configured to effect a second function signal transmission between the charger device and the device to be charged; the second function signal is different from the first function signal, and neither is a charging function signal; the second function signal is acquired by the first processing module through the first pin and whereby the charger device is controlled to charge the device to be charged through the second pin; the charger device comprises the first USB controller circuit, and the device to be charged comprises the second USB controller circuit.
